(19) United States
(12) Patent Application Publication
(10) Pub. No.: US 2007/0064045 A1
(43) Pub. Date: Mar. 22, 2007

(54) Inkjet image forming apparatus having cap member

(75) Inventor: Gui-taek Lim, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/501,809

(22) Filed: Aug. 10, 2006

(30) Foreign Application Priority Data
Sep. 20, 2005 (KR) 2005-87282

(51) Int. Cl. B41J 2/165

(52) U.S. Cl. 347/29

(57) ABSTRACT

An inkjet image forming apparatus includes an array inkjet head, a cap member, and a pressure regulator. The array inkjet head has a nozzle unit and a plurality of nozzle plates disposed on the nozzle unit and the cap member has a plurality of inside caps to enclose the corresponding nozzle plates. The pressure regulator regulates the pressure of inner spaces of the inside caps.

### CROSS-REFERENCE TO RELATED APPLICATIONS

This application claims the priority of Korean Patent Application No. 10-2005-0087282, filed on Sep. 20, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus having a cap member to cap a nozzle unit.

2. Description of the Related Art

An inkjet image forming apparatus is an apparatus firing ink onto paper through a shuttle type inkjet head that reciprocates in a direction perpendicular to a delivery direction of the paper to form an image. The inkjet head has a nozzle unit where a plurality of nozzles that eject ink are formed. The ink is fired as ink droplets.

Recently, an attempt for realizing a high-speed printing using an array type inkjet head having a nozzle unit of a length in a sub-scanning direction that corresponds to a width of the paper, instead of the shuttle type inkjet head, has been made. In the image forming apparatus adopting the array type inkjet head, the array type inkjet head is fixed and only paper is moved. Therefore, a driving device of the array type inkjet image forming apparatus is simple and thus a high-speed printing is possible. In the array type inkjet image forming apparatus, the length in the sub-scanning direction of the nozzle unit is about 210 mm so as to correspond to a size A4 sheet, for example (without consideration of a printing margin in the width direction of paper). Assuming that printing is performed at a resolution of 600 dpi (dot per inch), a number of nozzles is about 5,000.

The ink droplets that are not successfully fired remain in an area of the nozzle unit. When the nozzle unit is exposed to air while a printing operation is not performed, ink droplets in the area of the nozzle unit can become solidified and foreign substance (e.g., fine dusts) from the air can become attached to the nozzle unit. The solidified ink or foreign substance can distort a firing direction of the ink and deteriorate an image quality. Also, when the ink on the nozzle unit solidifies, the nozzle unit can become blocked. To prevent such a problem, the nozzle unit is covered with a cap member and isolated from an air outside the nozzle unit while a printing operation is not performed. With the nozzle unit capped, when an outside environment, i.e., temperature and pressure change, a pressure of an inside of the cap member also changes. The pressure change may destroy a meniscus of the ink formed in the inside of the nozzle to cause a leakage of ink.

### SUMMARY OF THE INVENTION

The present general inventive concept provides an array type inkjet image forming apparatus to regulate a pressure of an inside of a cap member when a nozzle unit is capped.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet image forming apparatus including an array inkjet head including a nozzle unit and a plurality of nozzle plates disposed on the nozzle unit, a cap member having a plurality of inside caps to enclose the corresponding nozzle plates, and a pressure regulator to regulate a pressure of an inner space of the plurality of inside caps.

The plurality of inside caps may be serially connected to communicate with each other. The pressure regulator may include an air vent to allow the inner space of the inside cap to communicate with outside air. The pressure regulator may include an outside cap to enclose the plurality of inside caps to form a buffer space, a first air vent to allow the inner space of the inside cap to communicate with the buffer space, and a second air vent to allow the buffer space to communicate with the outside air.

The plurality of inside caps may be classified into a plurality of inside cap groups, and the plurality of inside caps that belong to the same inside cap group are serially connected to communicate with each other. The pressure regulator may include a plurality of air vents to allow the inner spaces of the plurality of inside cap groups to communicate with the outside air. The pressure regulator may include an outside cap to enclose the plurality of inside cap groups to form a buffer space, a first air vent to allow the inner space of the inside cap to communicate with the buffer space, and a second air vent allowing the buffer space to communicate with the outside air.

The foregoing and/or other aspects and utilities of the present general inventive concept may also be achieved by providing an array type inkjet image forming apparatus including an array inkjet head having a nozzle unit and a plurality of nozzle plates disposed thereon, and wherein a cap member to cap the nozzle unit, the cap member includes a plurality of inside caps to enclose at least one of the nozzle plates, and an air vent to allow the plurality of inner spaces of the inside caps to communicate with the outside air.

The foregoing and/or other aspects and utilities of the present general inventive concept may also be achieved by providing an image forming apparatus, including nozzle plates arranged on a nozzle unit in a main scanning direction and a cap member having a plurality of caps to cover corresponding ones of the nozzle plates, a plurality of communication ports to connect the adjacent caps, and an air vent formed on at least one of the cap to communicate with an outside thereof.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an inkjet image forming apparatus according to an embodiment of the present general inventive concept;

FIG. 2 is a view illustrating a nozzle unit of the inkjet image forming apparatus of FIG. 1;

FIG. 3 is a view illustrating a device having a cap member to perform a capping operation in the inkjet image forming apparatus of FIG. 1;

FIG. 4 is an exploded perspective view illustrating the device of FIG. 3;

FIG. 5 is a view illustrating a nozzle is capped by the cap member in the device of FIG. 3;

FIG. 6 is a view illustrating an inner space between the nozzle unit and the cap member of FIG. 3;

FIG. 7 is a view illustrating a cap member according to an embodiment of the present general inventive concept;

FIG. 8 is a view illustrating a cap member according to an embodiment of the present general inventive concept;

FIG. 9 is a view illustrating a cap member according to an embodiment of the present general inventive concept;

FIG. 10 is a view illustrating a cap member according to an embodiment of the present general inventive concept; and

FIGS. 11 and 12 are exemplary views illustrating air vents of the pressure regulator of FIG. 10.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

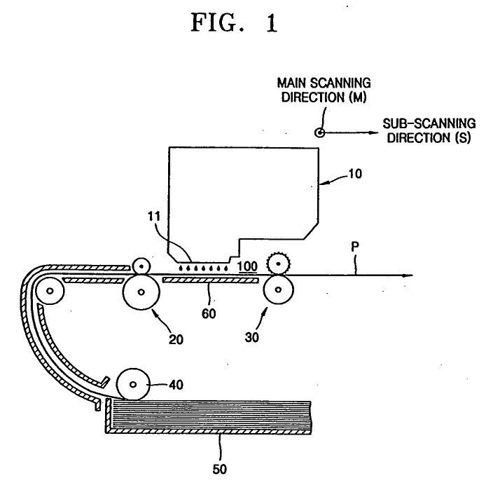

FIG. 1 is a view illustrating an inkjet image forming apparatus according to an embodiment of the present general inventive concept. Referring to FIG. 1, paper P picked up from a paper-supply cassette 50 by pick-up rollers 40 is moved in a sub-scanning direction S by a delivery unit 20. An inkjet head 10 is disposed above paper P. The inkjet head 10 fires ink onto the paper P at a stationary position to print an image on the paper P. The paper P passes over and is supported by a platen 60.

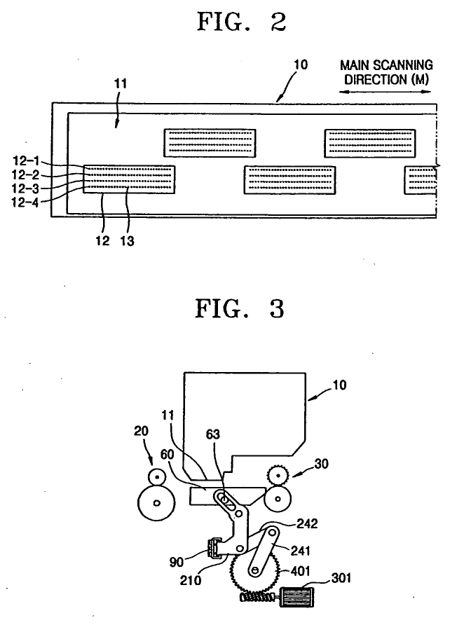

The inkjet head 10 of the present embodiment is an array type inkjet head having a nozzle unit 11 of a length in a main scanning direction M that corresponds to a width of the paper P. FIG. 2 is a view illustrating the nozzle unit 11 the inkjet image forming apparatus of FIG. 1. Referring to FIG. 2, the nozzle unit 11 has a plurality of nozzle plates 12 arranged in zigzags in the main scanning direction M. Each nozzle plate 12 has a plurality of nozzles 13 to eject the ink. The nozzle plate 12 may have a plurality of nozzle rows 12-1, 12-2, 12-3, and 12-4. Also, the respective nozzle rows 12-1, 12-2, 12-3, and 12-4 can fire ink of the same color, or ink of different colors (e.g., cyan, magenta, yellow, and black), respectively. FIG. 2 illustrates an example of the nozzle unit 11 and the scope of the present general inventive concept. Though not illustrated, the inkjet head 10 includes a chamber in which an ejecting element (e.g., a piezoelement, a heater, etc.) to communicate with each of the plurality of nozzles 13 and to provide a pressure used to eject the ink is formed, and a channel to supply the ink to the chamber. Since the chamber, the ejecting element, and the channel are well known to those skilled in the art, detailed descriptions thereof will be omitted.

Referring to FIG. 1, the platen 60 is disposed to face the nozzle unit 11 to support a backside of the paper P and forms a paper-delivery path 100. The platen 60 is disposed such that the nozzle unit 11 of the inkjet head 10 maintains a predetermined interval (e.g., about 0.5-2 mm) from the paper P. A discharge unit 30 to discharge the printed paper P is disposed on an exit side of the inkjet printhead 10.

When the nozzle unit 11 is exposed to air while a printing operation is not performed, ink droplets in an area of the nozzle unit 11 can become solidified and foreign substance (e.g., fine dusts) from the air can become attached on the nozzle unit 11. The solidified ink or foreign substance distorts a firing direction of the ink so as to deteriorate a print quality of inkjet head 10. Also, the ink on the nozzle unit 11 is constantly solidifying or drying, so that the nozzles 13 can become blocked due to solidified ink. Since the inkjet head 10 prints the image at a fixed position, a white line can appear on a printed image when a part of the nozzles 13 is blocked. A capping operation is performed to cover the nozzle unit 11, so as to block outside air to prevent a drying of the ink on the nozzles 13 when the printing operation is not performed for more than a predetermined period of time.

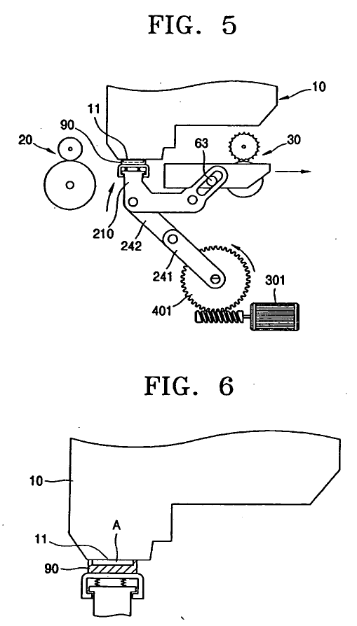

FIG. 3 is a view illustrating a cap member 90 to perform a capping operation in the inkjet image forming apparatus of FIG. 1. Referring to FIGS. 1-3, the inkjet image forming apparatus includes the cap member 90 to cap the nozzle unit 11. The cap member 90 can be manufactured using an elastic material such as rubber. In the image forming apparatus of the present embodiment, the platen 60 escapes from the lower portion of the nozzle unit 11 to perform the capping operation, as illustrated in FIG. 5. The cap member 90 is positioned below the platen 60 and performs the capping operation on the nozzle unit 11 when the platen 60 is moved to a position illustrated in FIG. 5.

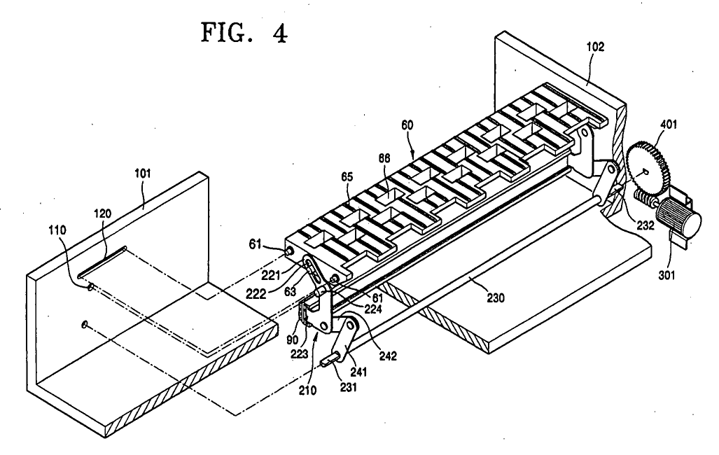

FIG. 4 is an exploded perspective view illustrating the device and the cap member 90 of FIG. 3. Referring to FIG. 4, a protuberance 61 is formed on both side portions of the platen 60. The protuberance 61 is inserted into a cam trace 120. A plurality of ribs 65 is formed on the platen 60 to support the backside of paper P The platen 60 has a receiving part 66. In a case where the printing operation is not performed for a predetermined period of time or the nozzles 13 are not used for the predetermined period of time during the printing operation, the ink in the neighborhood of the nozzles 13 dries and a viscosity of ink is raised, so that an ejection malfunction is generated. A spitting operation is performed to eject the ink every predetermined period of time so as to remove the ink having the raised viscosity. The spat ink is received in the receiving part 66.

A cap arm 210 is rotatably coupled with sidewalls 101 and 102. A rotational shaft 224 of the cap arm 210 is inserted into a hole 110 formed in the sidewalls 101 and 102. The cap arm 210 has one end 221 coupled with the platen 60 and the other end 223 where the cap member 90 is installed. The one end 221 has a long hole-shaped slot 222 defined therein. A guide pole 63 formed on the side portion of the platen 60 is inserted into the slot 222. A shaft 230 is rotatably supported by the sidewalls 101 and 102. Chamfer parts 231 and 232 are formed at both ends of a shaft 230. A pair of first connection arms 241 is coupled with the chamfer parts 231 and 232 of the shaft 230 and a pair of second connection arms 242 connects a pair of first connection arms 241 with the cap arm 210. A gear 401 is coupled with the chamfer part 232. A maintenance motor 301 rotates the gear 401.

Referring to FIG. 3, the platen 60 is disposed at the printing position to support the backside of paper P. The cap member 90 is disposed below the platen 60. At the printing position, the ink is ejected onto the paper P to print the image while the paper P is moved through the paper-delivery path 100. Also, when the paper P is not present on the paper-delivery path 100 before the image is printed or after the printing operation is performed several times, the spitting operation is performed. The plurality of the receiving parts 66 are formed to correspond to the plurality of nozzle plates 12. Therefore, the spat ink falls into the receiving parts 66 of the platen 60.

When the maintenance motor 301 rotates the gear 401 counterclockwise, the cap arm 210 is rotated. The slot 222 pushes a guide pole 63. The platen 60 is moved to the discharge unit 30 along a cam trace 120. Referring to FIG. 4, the platen 60 is disposed at a maintenance position that opens the lower portion of the nozzle unit 11, and the cap member 90 caps the nozzle unit 11. When the maintenance motor 301 rotates the gear 401 clockwise, the cap member 90 is spaced from the nozzle unit 11 and the platen 60 is moved from the maintenance position to the printing position.

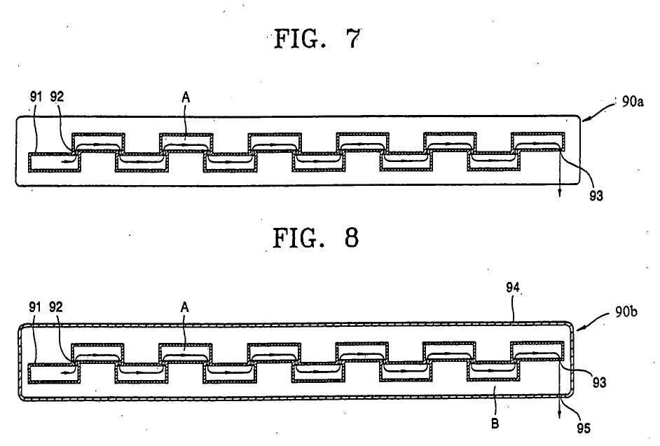

FIG. 6 is a view illustrating an inner space between the cap member 90 and the nozzle unit 11 of FIG. 3. Referring to FIG. 6, when the cap member 90 caps the nozzle unit 11, an inner space A defined by the cap member 90 and the nozzle unit 11 is formed. A volume of the inner space A should be as small as possible. With the nozzle unit 11 capped, a moisture of the ink exposed on and/or in the nozzles 13 evaporates to the inner space A. When the inner space A is saturated, the moisture of the ink no longer evaporates. When the volume of the inner space A is small, the inner space A is quickly saturated. In other words, an amount of moisture required to saturate the inner space A is reduced. When the volume of the inner space A is large, more of the moisture of ink within the nozzles 13 evaporates and therefore raises the viscosity of the ink. A high viscosity ink can block the nozzles 13 or distort an ejecting direction of the ink. Also, the spitting operation is performed when the nozzle unit 11 is capped so as to saturate the inner space A. When the volume of the inner space A is small, a number of the spitting operations required to saturate the inner space A can be reduced and thus an ink consumption can be reduced. FIG. 7 is a view illustrating a cap member 90a according to an embodiment of the present general inventive concept. Referring to FIG. 7, the cap member 90a has inside caps 91 to enclose the plurality of nozzle plates 12, respectively. The volume of the inner space A can be reduced by the inside caps 91. That is, the inside caps 91 closely cover the plurality of nozzle plates 12 to reduce the volume of the inner space A.

When a pressure or a temperature of an outside changes when the nozzle unit 11 is capped, air in the inner space A can expand or contract. This pressure change is transferred to the inside of the nozzles 13 and can destroy a meniscus of the ink within the nozzles 13. When the meniscus is destroyed, the ink can flow out through the nozzles 13. Also, the ink cannot be ejected, so that the print quality of inkjet head 10 deteriorates. To prevent the pressure change from destroying the meniscus, the inkjet image forming apparatus includes a pressure regulator to regulate the pressure of the inner space A when the nozzle unit 11 is capped. As one example of the pressure regulator, the inner space A is allowed to communicate with the outside air through an air vent 93 and a communication port 92, so that the pressure change of the inner space A is prevented. That is, the regions inside caps 91 are connected to each other through the communication ports 92 formed therebetween, and an end of the inside cap 91 is formed with the air vent 93.

FIG. 8 is a view illustrating a cap member 90b according to an embodiment of the present general inventive concept. Referring to FIGS. 7 and 8, a plurality of inside caps 91 are connected with each other by a plurality of communication ports 92 in series. In the embodiments illustrated in FIGS. 7 and 8, one inside cap 91 can enclose more than two nozzle plates 12. With such a structure, the pressure change of the inner spaces A of respective inside caps 91 can be mutually absorbed. An air vent 93 is formed so as to allow the inner spaces A of the plurality of inside caps 91 to communicate with the outside air. A number of the air vents 93 should be kept as low as possible. Since the capping operation is to prevent the drying of the nozzle unit 11, the low number of air vents 93 can be installed so that a pressure control is achieved. The pressure control minimizes the pressure change. Since the inner space A is allowed to communicate with the outside air through the air vent 93, the pressure change that can not be absorbed by the inner spaces A is regulated.

Referring to FIG. 8, the cap member 90b includes an outside cap 94 to enclose the inside caps 91. With such a structure, a buffer space B is defined therein by the plurality of inside caps 91 and the outside cap 94. The inner spaces A of the inside caps 91 are allowed to communicate with the buffer space B through the first air vent 93. The outside cap 94 has the second air vent 95 allowing the buffer space B to communicate with the outside air. Since the inner space A is allowed to communicate with the buffer space B, the pressure change that can not be absorbed by the inner spaces A of the entire inside caps 91 is regulated. Also, since the buffer space B is allowed to communicate with the outside air, the pressure change that cannot be absorbed by the buffer space B is regulated. With such a structure, it is possible to regulate the pressure of the inner space A and to minimize a damage from when the cap member 90 isolates the nozzle unit 11 from the outside air.

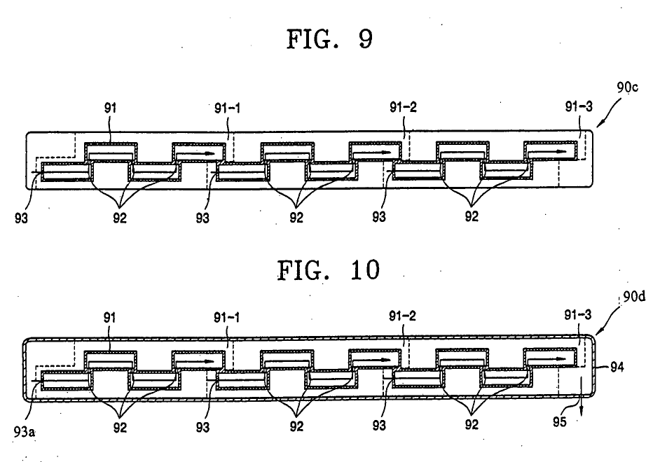

Referring to FIGS. 7 and 8, the plurality of inside caps 91 can serially communicate with each other but the configuration of the inside caps 91 is not limited thereto. Therefore, the nozzle unit 11 of the inkjet head 10 that corresponds to the width of paper having a large width (e.g., A3 paper) has a very long length. FIG. 9 is a view illustrating a cap member 90c according to an embodiment of the present general inventive concept. FIG. 10 is a view illustrating a cap member 90d according to an embodiment of the present general inventive concept. Referring to FIGS. 9 and 10, the inside caps 91 may be classified into several groups rather than serially connected to all of the inside caps 91. Referring to FIG. 9, three inside cap groups 91-1, 91-2, and 91-3 are exemplarily illustrated. Three inside caps cover the inside cap groups 91-1, 91-2, and 91-3. The three inside caps 91 to cover the inside cap groups 91-1, 91-2, and 91-3 can serially communicate with each other through the communication port 92. Each of the inside cap groups 91-1, 91-2, and 91-3 has the air vent 93 to allow the inner space A to communicate with the outside air. Referring to FIG. 10, the cap member 90d may also have the outside cap 94 to enclose the plurality of inside cap groups 91-1, 91-2, and 91-3. The inner spaces A of the inside cap groups 91-1, 91-2, and 91-3 can communicate with the buffer space B through the first air vent 93a. The outside cap 94 has the second air vent 95 to allow the buffer space B to communicate with the outside air. Effects according to the embodiments illustrated in FIGS. 9 and 10 are similar to those described with reference to FIGS. 7 and 8.

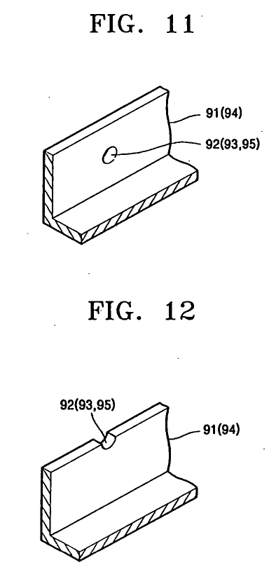

FIGS. 11 and 12 are exemplary views illustrating the air vents 92, 93, and 95 of the pressure regulator of FIG. 10. Referring to FIGS. 11 and 12, the air vents 92, 93, and 95 may have a diameter of about 0.5 mm. Also, the air vents 92, 93, and 95 may have a shape to completely pass through the inside cap 91 (or the outside cap 94) as illustrated in FIG. 11, or have a groove shape formed in an upper portion of the inside cap 91 (or the outside cap 94) that meets a bottom of the nozzle unit 11.

As described above, according to an inkjet image forming apparatus of the present general inventive concept, it is possible to reduce an amount of ink evaporation through a minimization of a volume of an isolated space when a nozzle unit is capped and to prevent an ejection malfunction and an ink leakage by an absorption of a pressure change of an inner space of a cap member due to a temperature and pressure change of an outside.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
an array inkjet head, comprising:
a nozzle unit, and
a plurality of nozzle plates disposed on the nozzle unit,
a cap member having a plurality of inside caps to enclose the corresponding nozzle plates; and
a pressure regulator to regulate a pressure of an inner space of the plurality of inside caps.

2. The apparatus of claim 1, wherein the plurality of inside caps are serially connected to communicate with each other.

3. The apparatus of claim 2, wherein the pressure regulator comprises an air vent to allow the inner space of the inside cap to communicate with outside air.

4. The apparatus of claim 2, wherein the pressure regulator comprises:
an outside cap to enclose the plurality of inside caps to form a buffer space;
a first air vent to allow the inner space of the inside cap to communicate with the buffer space; and
a second air vent to allow the buffer space to communicate with the outside air.

5. The apparatus of claim 1, wherein the plurality of inside caps are classified into a plurality of inside cap groups, and the plurality of inside caps that belong to the same inside cap group are serially connected to communicate with each other.

6. The apparatus of claim 5, wherein the pressure regulator comprises a plurality of air vents to allow the inner spaces of the plurality of inside cap groups to communicate with the outside air.

7. The apparatus of claim 5, wherein the pressure regulator comprises:
an outside cap to enclose the plurality of inside cap groups to form a buffer space;
a first air vent to allow the inner spaces of the inside caps to communicate with the buffer space; and
a second air vent to allow the buffer space to communicate with the outside air.

8. An array type inkjet image forming apparatus, comprising:
an array inkjet head having a nozzle unit and a plurality of nozzle plates disposed thereon; and
wherein a cap member to cap the nozzle unit, the cap member comprises:
a plurality of inside caps, each to enclose at least one of the nozzle plates, and
an air vent to allow the inner spaces of the plurality of inside caps to communicate with outside air.

9. The apparatus of claim 8, wherein:
the cap member further comprises an outside cap to enclose the plurality of inside caps; and
the air vent comprises a first air vent to allow the plurality of inner spaces of the inside caps to communicate with a buffer space between the outside cap and the inside caps and a second air vent allowing the buffer space to communicate with the outside air.

10. An image forming apparatus, comprising:
nozzle plates arranged on a nozzle unit in a main scanning direction; and
a cap member, comprising:
a plurality of caps to cover corresponding ones of the nozzle plates,
a plurality of communication ports to connect the adjacent caps, and
an air vent formed on at least one of the cap to communicate with an outside thereof.

11. The image forming apparatus of claim 10, wherein the cap member further comprises:
an outside cap to surround the plurality of caps to cover the nozzle plate; and
a second vent provided on the outside cap to control a pressure on an area between the plurality of caps and the outside cap.

12. The image forming apparatus of claim 10, wherein the caps comprise a plurality of groups of sub-caps, and the plurality of communication ports are formed between the adjacent sub-caps of the respective groups.

13. The image forming apparatus of claim 12, wherein the air vent comprises a plurality of sub-air vents formed on at least one of the sub-caps of the respective groups.

14. The image forming apparatus of claim 13, wherein the cap member comprises:
an outside cap to surround the plurality of groups of sub-caps; and
a second vent formed in the outside cap to communicate with the plurality of the sub-air vents.

15. The image forming apparatus of claim 12, wherein at least one of the sub-caps of each group comprises a corresponding one of the communication ports to communicate with the adjacent sub-cap and a sub-air vent to communicate with the outside thereof.

16. The image forming apparatus of claim 10, wherein the caps comprise a wall to define an inner space of the cap with the nozzle unit, and the communication ports are formed on a portion of the wall to be connected to the wall of the adjacent cap.
